(19) United States
(12) Patent Application Publication
(10) Pub. No.: US 2024/0393528 A1
(43) Pub. Date: Nov. 28, 2024

(54) OPTICAL FIBER, OPTICAL FIBER RIBBON, AND OPTICAL FIBER CABLE

(71) Applicant: SUMITOMO ELECTRIC INDUSTRIES, LTD., Osaka (JP)

(72) Inventors: Shota TOKAJI, Osaka (JP); Masataka EBINA, Osaka (JP)

(21) Appl. No.: 18/788,285

(22) Filed: Jul. 30, 2024

(30) Foreign Application Priority Data
May 29, 2024 (JP) 2024-087493

(51) Int. Cl. G02B 6/02; C03C 25/106; C03C 25/326; C09D 4/06; C09D 7/63; C09D 175/14; G02B 6/44

(52) U.S. Cl. CPC G02B 6/02395; C03C 25/106; C03C 25/326; C09D 4/06; C09D 7/63; C09D 175/14; G02B 6/4403

(57) ABSTRACT

An optical fiber according to the present disclosure includes: a glass fiber including a core and a cladding; and a coating resin layer covering the glass fiber, in which the coating resin layer includes a cured product of a resin composition containing a photopolymerizable compound and a phosphine oxide-based photopolymerization initiator, and trimethylbenzoic acid, a content of the phosphine oxide-based photopolymerization initiator is 0.001% by mass or more and 0.5% by mass or less based on a total amount of the optical fiber, and a content of trimethylbenzoic acid is 0.001% by mass or more and 0.2% by mass or less based on the total amount of the optical fiber.

### TECHNICAL FIELD

The present disclosure relates to an optical fiber, an optical fiber ribbon, and an optical fiber cable.

### CROSS-REFERENCE

The present application claims priority based on Japanese Patent Application No. 2024-087493, filed May 29, 2024, the entire disclosure described in the Japanese Patent Application is incorporated herein by reference.

### BACKGROUND

Generally, an optical fiber is provided with a coating resin layer for protecting a glass fiber, which is an optical transmission medium. The coating resin layer includes, for example, a primary resin layer that is in contact with the glass fiber, and a secondary resin layer formed on the outer side of the primary resin layer. The primary resin layer and the secondary resin layer are each formed from an ultraviolet-curable resin composition containing a photopolymerizable compound and a photopolymerization initiator.

When connecting an optical fiber, it is necessary to remove a portion of the coating resin layer from the glass fiber. In JP 2019-61157 A, attention was paid to the adhesion angle of mineral oil to the primary resin layer and the elastic modulus of the secondary resin layer, and it is disclosed that removability of the coating resin layer is adjusted.

### SUMMARY

An optical fiber according to an embodiment of the present disclosure includes: a glass fiber including a core and a cladding; and a coating resin layer covering the glass fiber, wherein the coating resin layer includes a cured product of a resin composition containing a photopolymerizable compound and a phosphine oxide-based photopolymerization initiator and trimethylbenzoic acid, a content of the phosphine oxide-based photopolymerization initiator is 0.001% by mass or more and 0.5% by mass or less based on a total amount of the optical fiber, and a content of the trimethylbenzoic acid is 0.001% by mass or more and 0.2% by mass or less based on the total amount of the optical fiber.

### BRIEF DESCRIPTION OF THE DRAWINGS

FIG. 1 is a schematic cross-sectional view illustrating an example of an optical fiber according to the present embodiment.

FIG. 2 is a schematic cross-sectional view illustrating an optical fiber ribbon according to an embodiment.

FIG. 3 is a schematic cross-sectional view illustrating the optical fiber ribbon according to an embodiment.

FIG. 4 is a plan view illustrating the appearance of the optical fiber ribbon according to an embodiment.

FIG. 5 is a schematic cross-sectional view illustrating an optical fiber cable according to an embodiment.

FIG. 6 is a schematic cross-sectional view illustrating the optical fiber cable according to an embodiment.

### DETAILED DESCRIPTION

When an optical fiber is immersed in oil such as mineral oil, the coating resin layer absorbs the oil, and the adhesive force of the coating resin layer to the glass fiber may deteriorate. An optical fiber is required to have a coating resin layer that has a certain adhesive force when immersed not only in water but also in oil. On the other hand, when an optical fiber is exposed to light such as fluorescent lamp light, a curing reaction of the coating resin layer proceeds over time, and the adhesive force of the coating resin layer to the glass fiber may increase excessively. When the adhesiveness of the coating resin layer to the glass fiber is too high, the coating removability is reduced, and when removing the coating resin layer from the glass fiber, a portion of the coating resin layer may remain on the outer periphery of the glass fiber.

An object of the present disclosure is to provide an optical fiber having a coating resin layer with reduced changes in adhesiveness and coating removability over time, an optical fiber ribbon, and an optical fiber cable.

According to the present disclosure, an optical fiber having a coating resin layer with reduced changes in adhesiveness and coating removability over time, an optical fiber ribbon, and an optical fiber cable can be provided.

### DESCRIPTION OF EMBODIMENTS OF PRESENT DISCLOSURE

First, the contents of embodiments of the present disclosure will be listed and described.

(1) An optical fiber according to an aspect of the present disclosure includes: a glass fiber including a core and a cladding; and a coating resin layer covering the glass fiber, in which the coating resin layer includes a cured product of a resin composition containing a photopolymerizable compound and a phosphine oxide-based photopolymerization initiator, and trimethylbenzoic acid, the content of the phosphine oxide-based photopolymerization initiator is 0.001% by mass or more and 0.5% by mass or less based on the total amount of the optical fiber, and the content of the trimethylbenzoic acid is 0.001% by mass or more and 0.2% by mass or less based on the total amount of the optical fiber.

In the production process for the optical fiber, the phosphine oxide-based photopolymerization initiator is involved in the polymerization of a photopolymerizable compound by being decomposed, while on the other hand, a portion thereof may remain in the optical fiber without being decomposed. When the optical fiber is exposed to light such as fluorescent lamp light, the decomposed phosphine oxide-based photopolymerization initiator may react with a molecule containing an oxygen atom or a hydrogen atom, such as water present in the reaction atmosphere, to form trimethylbenzoic acid. When trimethylbenzoic acid is formed, since trimethylbenzoic acid promotes a reaction between a silane coupling agent included in the primary resin layer and the glass fiber, it may be difficult to remove the coating resin layer from the glass fiber. On the other hand, when the content of trimethylbenzoic acid in the optical fiber is small, the reaction between the silane coupling agent and the glass fiber may not proceed sufficiently, and an appropriate adhesive force between the glass fiber and the coating resin layer is less likely to occur.

With regard to the optical fiber according to the present embodiment, since the content of the phosphine oxide-based photopolymerization initiator is 0.001% by mass or more and 0.5% by mass or less based on the total amount of the optical fiber, and the content of trimethylbenzoic acid is 0.001% by mass or more and 0.2% by mass or less based on the total amount of the optical fiber, the changes in adhesiveness and coating removability over time can be reduced.

(2) With regard to the above (1), from the viewpoint of further reducing the changes in adhesiveness and coating removability over time, the above-described phosphine oxide-based photopolymerization initiator may include at least one selected from the group consisting of 2,4,6-trimethylbenzoyldiphenylphosphine oxide, 2,4,6-trimethylbenzoylphenylphosphonic acid ethyl ester, phenylbis(2,4,6-trimethylbenzoyl)phosphine oxide, and tri[phenyl(2,4,6-trimethylbenzoyl)phosphinic acid] polyethylene glycol ester.

(3) With regard to the above (2), from the viewpoint of further reducing the changes in adhesiveness and coating removability over time, the phosphine oxide-based photopolymerization initiator may be 2,4,6-trimethylbenzoyldiphenylphosphine oxide, and the content of 2,4,6-trimethylbenzoyldiphenylphosphine oxide may be 0.001% by mass or more and 0.1% by mass or less based on the total amount of the optical fiber.

(4) With regard to the above (2), from the viewpoint of further reducing the changes in adhesiveness and coating removability over time, the phosphine oxide-based photopolymerization initiator may be 2,4,6-trimethylbenzoylphenylphosphonic acid ethyl ester, and the content of 2,4,6-trimethylbenzoylphenylphosphonic acid ethyl ester may be 0.001% by mass or more and 0.5% by mass or less based on the total amount of the optical fiber.

(5) With regard to the above (2), from the viewpoint of further reducing the changes in adhesiveness and coating removability over time, the phosphine oxide-based photopolymerization initiator may be phenylbis(2,4,6-trimethylbenzoyl)phosphine oxide, and the content of phenylbis(2,4,6-trimethylbenzoyl)phosphine oxide may be 0.001% by mass or more and 0.5% by mass or less based on the total amount of the optical fiber.

(6) With regard to the above (2), from the viewpoint of further reducing the changes in adhesiveness and coating removability over time, the phosphine oxide-based photopolymerization initiator may be tri[phenyl(2,4,6-trimethylbenzoyl)phosphinic acid] polyethylene glycol ester, and the content of tri[phenyl(2,4,6-trimethylbenzoyl)phosphinic acid] polyethylene glycol ester may be 0.001% by mass or more and 0.5% by mass or less based on the total amount of the optical fiber.

(7) An optical fiber ribbon according to an aspect of the present disclosure includes: a plurality of the optical fibers according to any one of the above (1) to (6) arranged in parallel; and a connecting resin layer covering and connecting a plurality of the optical fibers. Such an optical fiber ribbon has excellent microbending resistance characteristics and excellent low-temperature characteristics.

(8) An optical fiber cable according to an aspect of the present disclosure includes the optical fiber ribbon according to the above (7) housed in a cable. Such an optical fiber ribbon cable has excellent microbending resistance characteristics and excellent low-temperature characteristics.

(9) An optical fiber cable according to an aspect of the present disclosure includes a plurality of the optical fibers according to any one of the above (1) to (6) housed in a cable. Such an optical fiber ribbon cable has excellent microbending resistance characteristics and excellent low-temperature characteristics.

### DETAILS OF EMBODIMENTS OF PRESENT DISCLOSURE

Specific examples of the optical fiber, optical fiber ribbon, and optical fiber cable according to embodiments of the present disclosure will be described with reference to the drawings as necessary. The present disclosure is not limited to these examples and is indicated by the claims, and all modifications made within the meanings and scopes equivalent to the claims are intended to be included. In the following description, the same reference numerals will be assigned to the same elements for the description of the drawings, and any overlapping description will not be repeated. In the present embodiment, the term (meth)acrylate means acrylate or methacrylate corresponding thereto, and the same also applies to other similar expressions such as (meth)acrylic acid.

### (Optical Fiber)

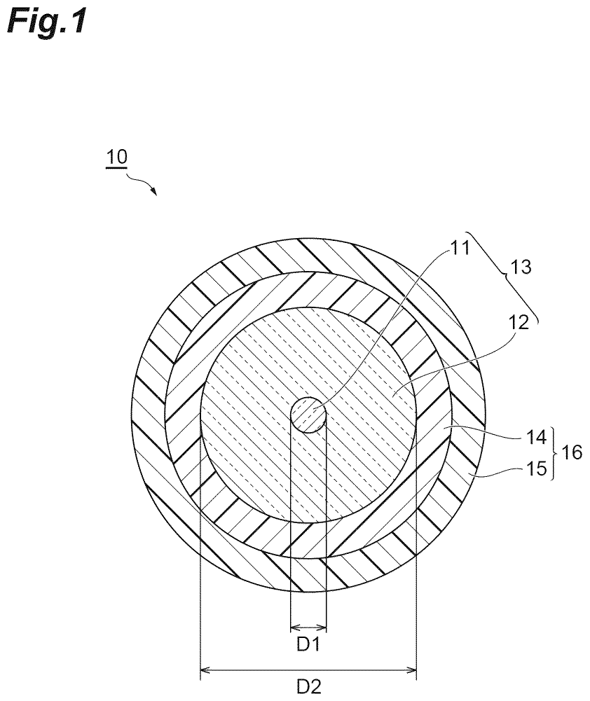

FIG. 1 is a schematic cross-sectional view illustrating an example of the optical fiber according to an embodiment. The optical fiber 10 includes a glass fiber 13, which is an optical transmission medium, and a coating resin layer 16 that is in contact with the glass fiber 13 and covers the glass fiber 13.

The glass fiber 13 includes a core 11 and a cladding 12 wrapping the core 11. The glass fiber 13 is a member made of glass and includes, for example, silica (SiO₂) glass. The glass fiber 13 transmits the light introduced into the optical fiber 10. The core 11 is provided in, for example, a region including the central axial line of the glass fiber 13. The core 11 contains, for example, pure SiO₂ glass, silica glass added with GeO₂, or silica glass added with fluorine element. The cladding 12 is provided in a region surrounding the core 11. The cladding 12 has a refractive index lower than the refractive index of the core 11. The cladding 12 contains, for example, pure SiO₂ glass, or SiO₂ glass added with fluorine element.

The coating resin layer 16 is a resin layer wrapping the cladding 12 and is formed using an ultraviolet-curable resin composition. The coating resin layer 16 has a primary resin layer 14 covering the outer periphery of the glass fiber 13, and a secondary resin layer 15 covering the outer periphery of the primary resin layer 14. The primary resin layer 14 is in contact with the outer peripheral surface of the cladding 12 and covers the entire cladding 12. The secondary resin layer 15 is in contact with the outer peripheral surface of the primary resin layer 14 and covers the entire resin layer 14. The thickness of the primary resin layer 14 is, for example, 10 μm or more and 50 μm or less. The thickness of the secondary resin layer 15 is, for example, 10 μm or more and 40 μm or less. The coating resin layer 16 may further include a colored resin layer covering the outer periphery of the secondary resin layer 15.

The coating resin layer 16 includes a cured product of a resin composition containing a photopolymerizable compound and a phosphine oxide-based photopolymerization initiator, and trimethylbenzoic acid, in which the content of the phosphine oxide-based photopolymerization initiator is 0.001% by mass or more and 0.5% by mass or less based on the total amount of the optical fiber, and the content of trimethylbenzoic acid is 0.001% by mass or more and 0.2% by mass or less based on the total amount of the optical fiber. As a result, an optical fiber with reduced changes in adhesiveness and coating removability over time can be obtained.

The contents of the phosphine oxide-based photopolymerization initiator and trimethylbenzoic acid in the optical fiber can be adjusted by changing the amount of the phosphine oxide-based photopolymerization initiator to be blended into the resin composition used for forming the coating resin layer, the production rate at the time of producing the optical fiber, and the time required until ultraviolet radiation is additionally irradiated after production of the optical fiber, and the like.

Examples of the phosphine oxide-based photopolymerization initiator include 2,4,6-trimethylbenzoyldiphenylphosphine oxide (Omnirad TPO-N, manufactured by IGM Resins B.V.), 2,4,6-trimethylbenzoylphenylphosphonic acid ethyl ester (Omnirad TPO-L, manufactured by IGM Resins B.V.), phenylbis(2,4,6-trimethylbenzoyl)phosphine oxide (Omnirad 819, manufactured by IGM Resins B.V.), tri[phenyl (2,4,6-trimethylbenzoyl)phosphinic acid]polyethylene glycol ester (Omnipol TP, manufactured by IGM Resins B.V.), and bis(2,6-dimethoxybenzoyl)-2,4,4-trimethylpentylphosphine oxide.

Omnipol TP has a structure represented by the following Formula (1). In Formula (1), a, b, and c are each independently an integer of 0 or greater, and a+b+c is 3 or greater.

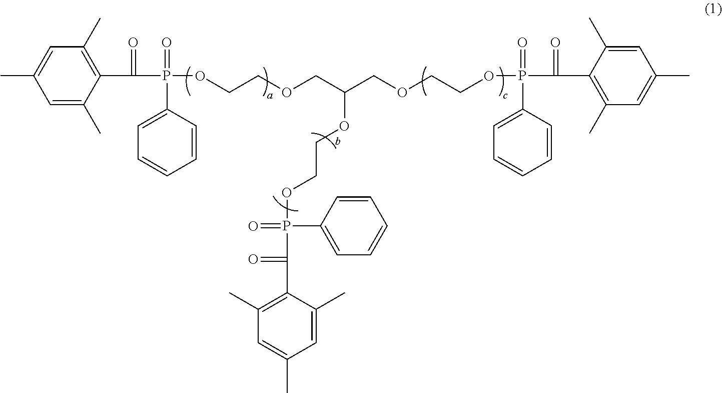

From the viewpoint of further reducing the changes in adhesiveness and coating removability over time, the phosphine oxide-based photopolymerization initiator may include, for example, at least one selected from the group consisting of 2,4,6-trimethylbenzoyldiphenylphosphine oxide, 2,4,6-trimethylbenzoylphenylphosphonic acid ethyl ester, phenylbis(2,4,6-trimethylbenzoyl)phosphine oxide, and tri[phenyl(2,4,6-trimethylbenzoyl)phosphinic acid] polyethylene glycol ester.

From the viewpoint of further reducing the changes in adhesiveness and coating removability over time, the phosphine oxide-based photopolymerization initiator may be 2,4,6-trimethylbenzoyldiphenylphosphine oxide, and the content of 2,4,6-trimethylbenzoyldiphenylphosphine oxide may be 0.001% by mass or more and 0.1% by mass or less based on the total amount of the optical fiber.

From the viewpoint of further reducing the changes in adhesiveness and coating removability over time, the phosphine oxide-based photopolymerization initiator may be 2,4,6-trimethylbenzoylphenylphosphonic acid ethyl ester, and the content of 2,4,6-trimethylbenzoylphenylphosphonic acid ethyl ester may be 0.001% by mass or more and 0.5% by mass or less based on the total amount of the optical fiber.

From the viewpoint of further reducing the changes in adhesiveness and coating removability over time, the phosphine oxide-based photopolymerization initiator may be phenylbis(2,4,6-trimethylbenzoyl)phosphine oxide, and the content of phenylbis(2,4,6-trimethylbenzoyl)phosphine oxide may be 0.001% by mass or more and 0.5% by mass or less based on the total amount of the optical fiber.

From the viewpoint of further reducing the changes in adhesiveness and coating removability over time, the phosphine oxide-based photopolymerization initiator may be tri[phenyl(2,4,6-trimethylbenzoyl)phosphinic acid] polyethylene glycol ester, and the content of tri[phenyl(2,4,6-trimethylbenzoyl)phosphinic acid]polyethylene glycol ester may be 0.001% by mass or more and 0.5% by mass or less based on the total amount of the optical fiber.

The resin composition according to the present embodiment may further contain another photopolymerization initiator different from the phosphine oxide-based photopolymerization initiator. Examples of the other photopolymerization initiator include 1-hydroxycyclohexyl phenyl ketone, 2,2-dimethoxy-2-phenylacetophenone, 1-(4-isopropylphenyl)-2-hydroxy-2-methylpropan-1-one, and 2-methyl-1-[4-(methylthio)phenyl]-2-morpholinopropan-1-one.

From the viewpoint of adjusting the Young's modulus of the coating resin layer, the photopolymerizable compound may include urethane (meth)acrylate. As the urethane (meth)acrylate, for example, a reaction product of a polyol compound, a polyisocyanate compound, and a hydroxyl group-containing (meth)acrylate compound can be used. Regarding the urethane (meth)acrylate, one kind thereof may be used alone, or two or more kinds thereof may be used in combination.

Examples of the polyol compound include polytetramethylene glycol, polypropylene glycol, and bisphenol A-ethylene oxide addition diol. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol mono(meth)acrylate.

From the viewpoint of adjusting the Young's modulus of the primary resin layer, the number average molecular weight (Mn) of the polyol compound may be 1000 or more and 10000 or less, 1500 or more and 9000 or less, or 2000 or more and 8000 or less. From the viewpoint of adjusting the Young's modulus of the secondary resin layer, the Mn of the polyol compound may be 300 or more and 3000 or less, 400 or more and 2500 or less, or 500 or more and 2000 or less.

As a catalyst used when synthesizing urethane (meth)acrylate, dibutyltin dilaurate, dibutyltin diacetate, dibutyltin malate, dibutyltin bis(2-ethylhexyl mercaptoacetate), dibutyltin bis(isooctyl mercaptoacetate), copper naphthenate, cobalt naphthenate, zinc naphthenate, triethylamine, 1,4-diazabicyclo[2.2.2]octane, 2,6,7-trimethyl-1,4-diazabicyclo[2.2.2]octane, bismuth octoate, bismuth 2-ethylhexanoate, bismuth neodecanoate, bismuth acetate, zirconium tetraacetylacetonate, normal-propyl zirconate, normal-butyl zirconate, or zirconium monoacetylacetonate may be used. From the viewpoints of easy availability or catalyst performance, dibutyltin dilaurate or dibutyltin diacetate may be used as the catalyst.

When urethane (meth)acrylate is synthesized, a lower alcohol having 5 or fewer carbon atoms may be used. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

From the viewpoint of imparting moderate toughness to the coating resin layer, the photopolymerizable compound may include epoxy (meth)acrylate. As the epoxy (meth)acrylate, a reaction product of a diglycidyl ether compound having a bisphenol skeleton and a compound having a (meth)acryloyl group such as (meth)acrylic acid can be used. Regarding the epoxy (meth)acrylate, one kind thereof may be used alone, or two or more kinds thereof may be used in combination.

Examples of the epoxy (meth)acrylate include a (meth)acrylic acid adduct of bisphenol A diglycidyl ether, a (meth)acrylic acid adduct of bisphenol AF diglycidyl ether, and a (meth)acrylic acid adduct of bisphenol F diglycidyl ether.

From the viewpoint of adjusting the Young's modulus of the secondary resin layer, the photopolymerizable compound may include at least one of urethane (meth)acrylate and epoxy (meth)acrylate.

The photopolymerizable compound may further include a photopolymerizable compound other than urethane (meth)acrylate and epoxy (meth)acrylate (hereinafter, referred to as “monomer”).

Examples of the monomer include a monofunctional monomer having one polymerizable group and a polyfunctional monomer having two or more polymerizable groups. Regarding the monomer, one kind thereof may be used, or two or more kinds thereof may be used in combination.

Examples of the monofunctional monomer include (meth)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxy diethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxy polyethylene glycol (meth)acrylate, and isobornyl (meth)acrylate; carboxy group-containing monomers such as (meth)acrylic acid, (meth)acrylic acid dimer, carboxyethyl (meth)acrylate, carboxypentyl (meth)acrylate, and ω-carboxy polycaprolactone (meth)acrylate; heterocyclic ring-containing monomers such as N-(meth)acryloylmorpholine, N-vinylpyrrolidone, N-vinylcaprolactam, N-(meth)acryloylpiperidine, N-(meth)acryloylpyrrolidine, 3-(3-pyridine)propyl (meth)acrylate, and cyclic trimethylolpropane formal acrylate; maleimide-based monomers such as maleimide, N-cyclohexylmaleimide, and N-phenylmaleimide; amide-based monomers such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylolpropane (meth)acrylamide; aminoalkyl (meth)acrylate-nased monomers such as aminoethyl (meth)acrylate, aminopropyl (meth)acrylate, N,N-dimethylaminoethyl (meth)acrylate, and tert-butylaminoethyl (meth)acrylate; and succinimide-based monomers such as N-(meth)acryloyloxymethylene succinimide, N-(meth)acryloyl-6-oxyhexamethylene succinimide, and N-(meth)acryloyl-8-oxyoctamethylene succinimide.

Examples of the polyfunctional monomer include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, neopentyl glycol di(meth)acrylate, isopentyldiol di(meth)acrylate, 3-ethyl-1,8-octanediol di(meth)acrylate, tricyclodecyl di(meth)acrylate; trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

From the viewpoint of adjusting the Young's modulus of the primary resin layer, the photopolymerizable compound may include an alkylene oxide-modified polyfunctional monomer. The alkylene oxide-modified polyfunctional monomer may have at least one selected from the group consisting of an ethylene oxide (EO) chain and a propylene oxide (PO) chain. The ethylene oxide chain can be represented by “(EO)n”, and the propylene oxide chain can be represented by “(PO)n”. n is an integer of 1 or greater and may be 2 or greater or 3 or greater, or may be 30 or less, 25 or less, or 20 or less. Examples of the alkylene oxide-modified polyfunctional monomer include an alkylene oxide-modified di(meth)acrylate and an alkylene oxide-modified tri(meth)acrylate.

Examples of the alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, and propylene oxide-modified neopentyl glycol di(meth)acrylate.

Examples of the alkylene oxide-modified tri(meth)acrylate include trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl]isocyanurate, and pentaerythritol tri(meth)acrylate.

From the viewpoint of being suitably applied to the primary resin layer, the resin composition according to the present embodiment may further contain a silane coupling agent.

The silane coupling agent is not particularly limited as long as it does not interfere with curing of the resin composition. Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyltrimethoxysilane, γ-glycidoxypropyltrimethoxysilane, γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl)propyl] tetrasulfide, bis-[3-(triethoxysilyl)propyl]disulfide, γ-trimethoxysilylpropyldimethylthiocarbamoyl tetrasulfide, and γ-trimethoxysilylpropylbenzothiazyl tetrasulfide.

The resin composition according to the present embodiment may further contain a leveling agent, an antifoaming agent, an antioxidant, a sensitizer, and the like.

From the viewpoint of storage stability, the viscosity at 25° C. of the resin composition according to the present embodiment may be 1000 mPa-s or greater, 1500 mPa-s or greater, or 2000 mPa-s or greater, and from the viewpoint of application properties, the viscosity at 25° C. may be less than 10000 mPa-s, 8000 mPa-s or less, or 6000 mPa-s or less.

The primary resin layer 14 can be formed by curing a resin composition containing a photopolymerizable compound including urethane (meth)acrylate, a phosphine oxide-based photopolymerization initiator, and a silane coupling agent.

From the viewpoint of improving the microbending resistance characteristics of the optical fiber, the Young's modulus of the primary resin layer 14 may be 0.80 MPa or less, 0.70 MPa or less, 0.60 MPa or less, or 0.55 MPa or less, at 23° C.±2° C. When the Young's modulus of the primary resin layer is 0.80 MPa or less, an external force is less likely to be transmitted to the glass fiber, and an increase in the transmission loss due to microbending tends to be easily suppressed. From the viewpoint of further improving the low-temperature characteristics of the optical fiber, the Young's modulus of the primary resin layer may be 0.10 MPa or greater, 0.15 MPa or greater, 0.20 MPa or greater, or 0.35 MPa or greater, at 23° C.±2° C.

The Young's modulus of the primary resin layer 14 can be measured by a Pullout Modulus (POM) method at 23° C. Two sites of an optical fiber are fixed with two chuck devices, the coating resin layer (primary resin layer and secondary resin layer) portion between the two chuck devices is removed, subsequently one of the chuck devices is fixed, and the other chuck device is gently moved to the opposite direction of the fixed chuck device. When the length of the portion of the optical fiber gripped by the moving chuck devices is designated as L, the amount of movement of the chuck is designated as Z, the outer diameter of the primary resin layer is designated as Dp, the outer diameter of the glass fiber is designated as Df, the Poisson's ratio of the primary resin layer is designated as n, and the load at the time of moving of the chuck device is designated as W, the Young's modulus of the primary resin layer can be determined from the following formula:

$$Young ’ s modulus ( MPa ) = ( ( 1 + n ) W / π LZ ) \times ln ( Dp / Df )$$

The secondary resin layer 15 can be formed by curing a resin composition containing a photopolymerizable compound including at least one of urethane (meth)acrylate and epoxy (meth)acrylate, and a phosphine oxide-based photopolymerization initiator.

From the viewpoint of improving the microbending resistance characteristics of the optical fiber, the Young's modulus of the secondary resin layer 15 may be 750 MPa or greater, 800 MPa or greater, 900 MPa or greater, or 1000 MPa or greater, at 23° C.±2° C. The upper limit value of the Young's modulus of the secondary resin layer is not particularly limited; however, from the viewpoint of imparting moderate toughness to the secondary resin layer, the upper limit value may be 2000 MPa or less, 1800 MPa or less, or 1500 MPa or less, at 23° C.±2° C.

The Young's modulus of the secondary resin layer 15 can be measured by, for example, the following method. First, an optical fiber is immersed in a mixed solvent of acetone and ethanol, and only the coating resin layer is pulled out into a tubular shape. At this time, the primary resin layer and the secondary resin layer are integrated; however, since the Young's modulus of the primary resin layer is 1/10000 or more and 1/1000 or less of the Young's modulus of the secondary resin layer, the Young's modulus of the primary resin layer can be neglected. Next, the solvent is eliminated from the coating resin layer by vacuum drying, subsequently a tensile test (tensile rate is 1 mm/min) is performed at 23° C., and the Young's modulus can be determined by the secant formula at 2.5% strain.

The method for producing the above-described optical fiber may include: an application step of applying a resin composition that is used for forming a coating resin layer, on the outer periphery of a glass fiber including a core and a cladding; and a curing step of curing the resin composition by irradiating the resin composition with ultraviolet radiation after the application step.

### (Optical Fiber Ribbon)

An optical fiber ribbon can be produced by using the optical fiber according to the present embodiment. The optical fiber ribbon according to the present embodiment includes the above-described optical fiber and a connecting resin layer covering and connecting a plurality of the above-described optical fibers. Since the optical fiber ribbon according to the present embodiment uses the above-described optical fiber, the optical fiber ribbon has excellent microbending resistance characteristics and low-temperature characteristics.

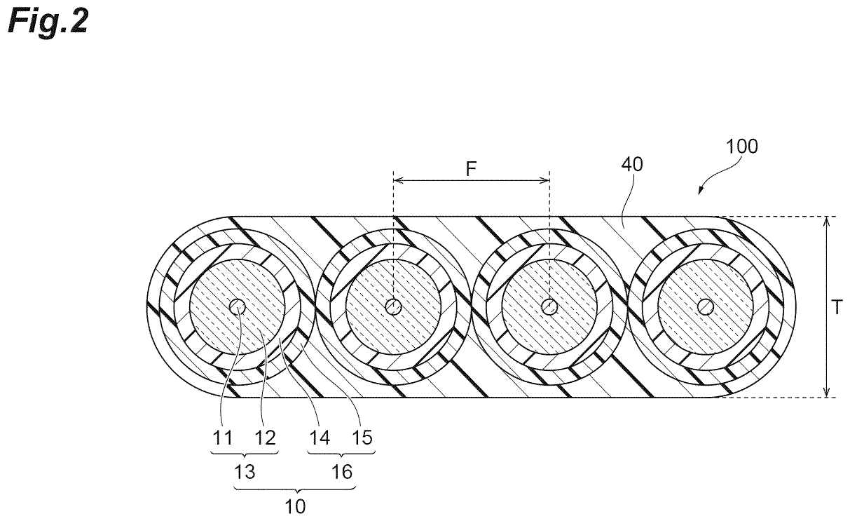

FIG. 2 is a schematic cross-sectional view illustrating the optical fiber ribbon according to an embodiment. The optical fiber ribbon 100 includes a plurality of optical fibers 10 and a connecting resin layer 40 in which the optical fibers 10 are (integrally) covered and connected by a resin for ribbon. In FIG. 2, four optical fibers 10 are shown as an example; however, the number of the optical fibers is not particularly limited. The optical fibers 10 may be integrated in a state of being arranged to be in contact with each other in parallel, or may be integrated in a state in which some or all of the optical fibers 10 are arranged in parallel at certain intervals. The distance between centers F of adjoining optical fibers 10 may be 220 μm or greater and 280 μm or less. When the distance between centers is set to 220 μm or greater and 280 μm or less, the optical fibers are easily placed in existing V-grooves, and an optical fiber ribbon having excellent batch splicing properties can be obtained. The thickness T of the optical fiber ribbon 100 may vary depending on the outer diameter of the optical fibers 10 and may be 164 μm or more and 285 μm or less.

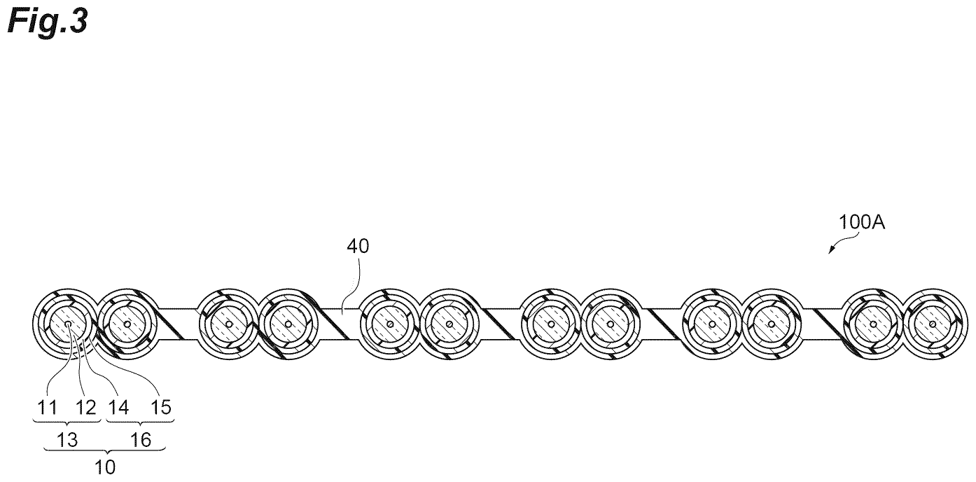

FIG. 3 is a schematic cross-sectional view illustrating an example of an optical fiber ribbon in which optical fibers are integrated in a state of being arranged in parallel at certain intervals. In the optical fiber ribbon 100A shown in FIG. 3, two optical fibers 10 are connected in pairs by a resin for ribbon at certain intervals. The resin for ribbon forms the connecting resin layer 40.

As the resin for ribbon, any resin material generally known as a ribbon material can be used. From the viewpoints of damage preventing properties for the optical fibers 10, easy separability, and the like, the resin for ribbon may contain a thermosetting resin such as a silicone resin, an epoxy resin, or a urethane resin; or an ultraviolet-curable resin such as epoxy acrylate, urethane acrylate, or polyester acrylate.

When the optical fibers 10 are arranged in parallel at certain intervals, that is, when adjoining optical fibers 10 are joined by a resin for ribbon interposed therebetween, without being in contact with each other, the thickness of the connecting part at the centers of the optical fibers 10 may be 150 μm or greater and 220 μm or less. From the viewpoint that the optical fiber ribbon is likely to be deformed when housed in a cable, the optical fiber ribbon may have depressions at the connecting part of the optical fibers. The depressions may be formed in a triangular shape having a narrowing angle on one surface of the connecting part.

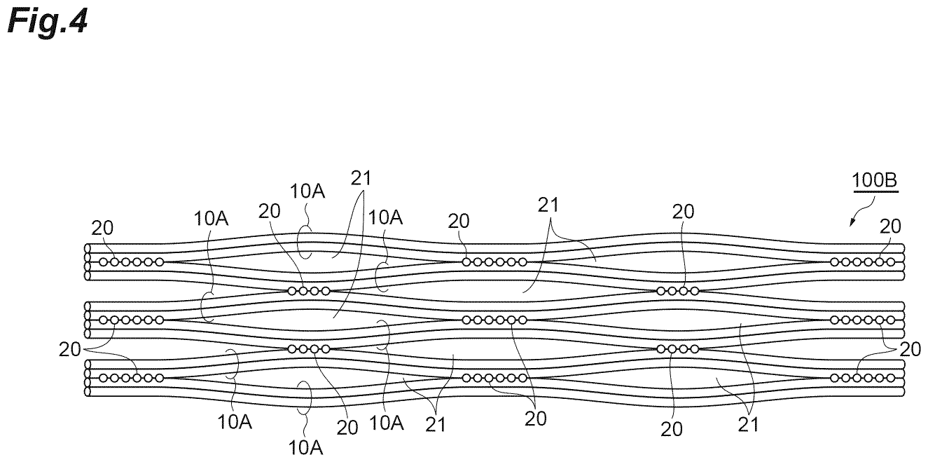

The optical fiber ribbon according to the present embodiment may have a connecting part and a non-connecting part intermittently in the longitudinal direction and the width direction. FIG. 4 is a plan view illustrating the appearance of the optical fiber ribbon according to an embodiment. The optical fiber ribbon 100B has a plurality of lines of optical fibers and a plurality of connecting parts 20 and non-connecting parts (separating parts) 21. The non-connecting parts 21 are formed intermittently in the longitudinal direction of the optical fiber ribbon. The optical fiber ribbon 100B is an intermittently connected-type optical fiber ribbon in which a connecting part 20 and a non-connecting part 21 are intermittently provided in the longitudinal direction for every two optical fibers 10A. The “connecting part” refers to a part in which adjoining optical fibers are integrated by a connecting resin layer interposed therebetween, and the “non-connecting part” refers to a part in which adjoining optical fibers are not integrated by a connecting resin layer interposed therebetween, and there are gaps between the optical fibers.

In the optical fiber ribbon having the above-described configuration, since non-connecting parts 21 are intermittently provided in the connecting parts 20 that are provided for every two cores, the optical fiber ribbon is easily deformable. Therefore, when the optical fiber ribbon is packaged in an optical fiber cable, the optical fiber ribbon can be easily rolled and packaged, and therefore, the optical fiber ribbon can be produced as an optical fiber ribbon appropriate for high-density packaging. Furthermore, since the connecting parts 20 can be easily torn by taking the non-connecting parts 21 as starting points, single core separation of the optical fibers 10 in the optical fiber ribbon is easily achieved.

### (Optical Fiber Cable)

An optical fiber cable according to the present embodiment has the above-described optical fiber ribbon housed in a cable. The optical fiber cable according to an embodiment of the present disclosure has the above-described optical fiber ribbon accommodated in a cable. The optical fiber cable according to the present embodiment may be an embodiment in which a plurality of the above-described optical fibers are housed in a cable without being covered with a resin for ribbon, and in the optical fiber cable according to another embodiment of the present disclosure, a plurality of the above-described optical fibers are accommodated in a cable. Since the optical fiber cable according to the present embodiment uses the above-described optical fiber or the above-described optical fiber ribbon, the optical fiber cable has excellent microbending resistance characteristics and low-temperature characteristics.

Examples of the optical fiber cable include a slotted optical fiber cable having a plurality of slots (grooves). Inside the slots, the above-described optical fiber ribbon can be packaged such that the packaging density in each slot is about 25% to 65%. The packaging density means the ratio of the cross-sectional area of the optical fiber ribbon to be packaged inside the slots with respect to the cross-sectional area of the slots.

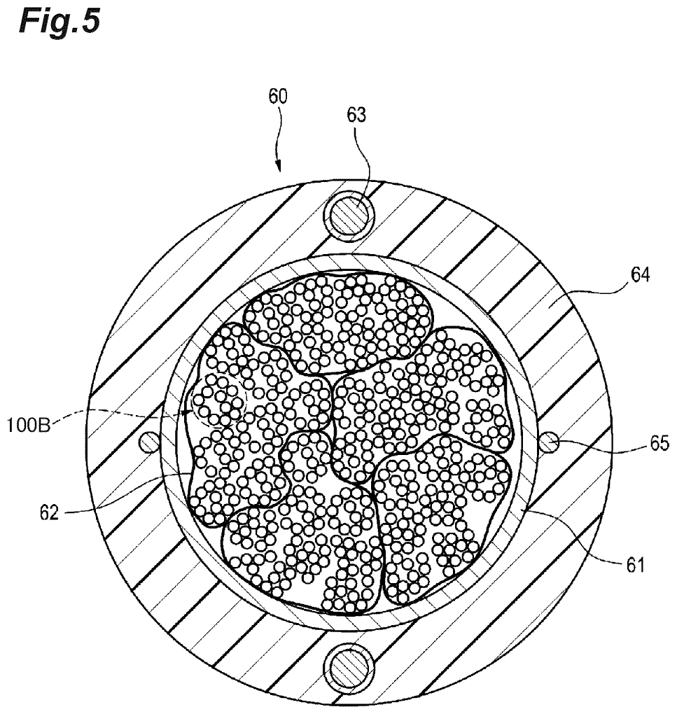

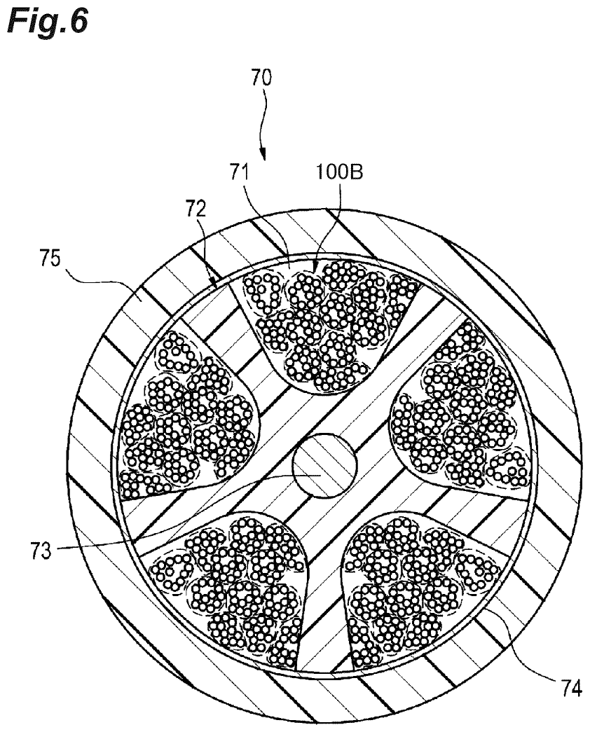

Examples of the optical fiber cable according to the present embodiment will be described with reference to FIG. 5 and FIG. 6. In FIG. 5 and FIG. 6, intermittently connected type optical fiber ribbons are housed; however, a plurality of optical fibers that are not covered with a resin for ribbon may be housed in a bundled state.

FIG. 5 is a schematic cross-sectional view of a slotless optical fiber cable 60 in which the above-mentioned intermittently connected-type optical fiber ribbon 100B is used. The optical fiber cable 60 has a cylindrical-type tube 61 and a plurality of optical fiber ribbons 100B. The plurality of optical fiber ribbons 100B may be bundled with an interposition 62 such as an aramid fiber. Furthermore, each of the plurality of optical fiber ribbons 100B may have a different marking. The optical fiber cable 60 has a structure formed by twisting a plurality of bundled optical fiber ribbons 100B, extrusion molding a resin that becomes the tube 61 around the optical fiber ribbons 100B, and covering the resultant with a sheath 64 together with a tension member 63. In a case where waterproofing is required, a water-absorbing yarn may be inserted inside the tube 61. The tube 61 can be formed by using, for example, a resin such as polybutylene terephthalate or a high-density polyethylene. On the outside of the tube 61, a tear string 65 may be provided.

FIG. 6 is a schematic cross-sectional view of a slotted optical fiber 70 that uses the above-mentioned intermittently connected-type optical fiber ribbon 100B. The optical fiber cable 70 has a slotted rod 72 having a plurality of slots 71, and a plurality of optical fiber ribbons 100B. The optical fiber cable 70 has a structure in which a plurality of slots 71 are radially provided on a slotted rod 72 having a tension member 73 at the center. The plurality of slots 71 may be provided in a shape twisted into a spiral shape or an SZ shape in the longitudinal direction of the optical fiber cable 70. In each slot 71, a plurality of optical fiber ribbons 100B that have been broken from a parallel state and arranged into a densely packed state are housed. Each of the optical fiber ribbons 100B may be bundled with a bundling material for identification. A press-winding tape 74 is wound around the slotted rod 72, and a sheath 75 is formed around the press-winding tape 74.

### EXAMPLES

Hereinafter, results of evaluation tests using the Examples and Comparative Examples according to the present disclosure will be shown, and the present disclosure will be described in more detail. Meanwhile, the present disclosure is not limited to these Examples.

### [Resin Composition for Primary Resin Layer]

### (Photopolymerizable Compound)

As photopolymerizable compounds, a urethane acrylate a obtained by reacting a polypropylene glycol having a molecular weight of 4000 with isophorone diisocyanate and hydroxyethyl acrylate, nonylphenol EO-modified acrylate (EO-NPA, manufactured by TOAGOSEI CO., LTD., trade name “ARONIX M-113”), N-vinylcaprolactam, and neopentyl glycol diacrylate were prepared.

### (Photopolymerization Initiator)

As phosphine oxide-based photopolymerization initiators, 2,4,6-trimethylbenzoyldiphenylphosphine oxide (manufactured by IGM Resins B.V., trade name “Omnirad TPO-N”), phenylbis(2,4,6-trimethylbenzoyl)phosphine oxide (manufactured by IGM Resins B.V., trade name “Omnirad 819”), 2,4,6-trimethylbenzoylphenylphosphonic acid ethyl ester (manufactured by IGM Resins B.V., trade name “Omnirad TPO-L”), and tri[phenyl(2,4,6-trimethylbenzoyl)phosphinic acid]polyethylene glycol ester (manufactured by IGM Resins B.V., trade name “Omnipol TP”) were prepared.

### (Silane Coupling Agent)

As a silane coupling agent, 3-mercaptopropyltrimethoxysilane (MPTS) was prepared.

The photopolymerizable compounds, photopolymerization initiators, and silane coupling agent were mixed in the blending amounts (parts by mass) indicated in Table 1 to produce resin compositions for the primary resin layer.

TABLE 1

| Resin composition | P1 | P2 | P3 | P4 | P5 | P6 |
|---|---|---|---|---|---|---|
| Urethane acrylate a | 75.0 | 75.0 | 75.0 | 75.0 | 75.0 | 75.0 |
| Nonylphenol EO- | 13.5 | 10.5 | 10.5 | 10.5 | 13.0 | 12.5 |
| modified acrylate | | | | | | |
| N-vinylcaprolactam | 7.0 | 7.0 | 7.0 | 7.0 | 7.0 | 7.0 |
| Neopentyl glycol | 3.0 | 3.0 | 3.0 | 3.0 | 3.0 | 3.0 |
| diacrylate | | | | | | |
| Omnirad TPO-N | 1.0 | — | — | — | 1.5 | 2.0 |
| Omnirad TPO-L | — | 4.0 | — | — | — | — |
| Omnirad 819 | — | — | 4.0 | — | — | — |
| Omnipol TP | — | — | — | 4.0 | — | — |
| MPTS | 0.5 | 0.5 | 0.5 | 0.5 | 0.5 | 0.5 |

### [Resin Composition for Secondary Resin Layer]

### (Photopolymerizable Compound)

As photopolymerizable compounds, a urethane acrylate b obtained by reacting a polypropylene glycol having a molecular weight of 1000 with isophorone diisocyanate and 2-hydroxyethyl acrylate, a urethane acrylate c obtained by reacting a polypropylene glycol having a molecular weight of 600 with isophorone diisocyanate and 2-hydroxyethyl acrylate, epoxy acrylate (acrylic acid adduct of bisphenol A diglycidyl ether, manufactured by OSAKA ORGANIC CHEMICAL INDUSTRY LTD., trade name “VISCOAT #540”), isobornyl acrylate, trimethylolpropane polyethoxy triacrylate (manufactured by Miwon Specialty Chemical Co., Ltd., trade name “Miramer M3150”), and trimethylolpropane triacrylate were prepared.

### (Photopolymerization Initiator)

As an alkylphenone-based photopolymerization initiator, 1-hydroxycyclohexyl phenyl ketone (manufactured by IGM Resins B.V., trade name “Omnirad 184”) was prepared, and as phosphine oxide-based photopolymerization initiators, Omnirad TPO-N, Omnirad TPO-L, Omnirad 819, and Omnipol TP were prepared.

The photopolymerizable compounds and photopolymerization initiators were mixed in the blending amounts (parts by mass) indicated in Table 2 to produce resin compositions for the secondary resin layer.

TABLE 2

| Resin composition | S1 | S2 | S3 | S4 | S5 | S6 | S7 | S8 |
|---|---|---|---|---|---|---|---|---|
| Urethane acrylate b | 35.0 | 35.0 | 35.0 | 35.0 | 35.0 | 35.0 | — | — |
| Urethane acrylate c | — | — | — | — | — | — | — | 60.0 |
| Epoxy acrylate | 25.0 | 25.0 | 25.0 | 25.0 | 25.0 | 25.0 | 60.0 | — |
| Isobornyl acrylate | 18.0 | 15.0 | 15.0 | 15.0 | 17.5 | 17.0 | 18.0 | 8.0 |
| Trimethylolpropane | 20.0 | 20.0 | 20.0 | 20.0 | 20.0 | 20.0 | — | — |
| triacrylate | | | | | | | | |
| Trimethylolpropane | — | — | — | — | — | — | 20.0 | 30.0 |
| polyethoxy | | | | | | | | |
| triacrylate | | | | | | | | |
| Omnirad 184 | 1.0 | 1.0 | 1.0 | 1.0 | 1.0 | 1.0 | 1.0 | 1.0 |
| Omnirad TPO-N | 1.0 | — | — | — | 1.5 | 2.0 | 1.0 | 1.0 |
| Omnirad TPO-L | — | 4.0 | — | — | — | — | — | — |
| Omnirad 819 | — | — | 4.0 | — | — | — | — | — |
| Omnipol TP | — | — | — | 4.0 | — | — | — | — |

### [Production of Optical Fiber]

A resin composition for primary coating and a resin composition for secondary coating were each applied on the outer peripheral surface of a glass fiber having a diameter of 125 μm. Next, each of the resin compositions was cured by irradiating the resin composition with ultraviolet radiation, a primary coating layer and a secondary coating layer were formed, and an optical fiber was produced. The thickness of the primary coating layer was set to 32 μm, and the thickness of the secondary coating layer was set to 28 μm, to produce an optical fiber having an outer diameter of 245 μm. Production of the optical fiber was carried out at a production speed of 3000 m/min. Furthermore, after the optical fiber was produced, the optical fiber was additionally subjected to irradiation with ultraviolet radiation as necessary. Test Examples 1 to 14 correspond to Examples, and Test Examples 15 to 18 correspond to Comparative Examples.

### [Evaluation]

The optical fiber of each Test Example was subjected to the following evaluation. The results are shown in Table 3, Table 4, and Table 5.

### (Contents of Phosphine Oxide-Based Initiator and Trimethylbenzoic Acid)

0.5 g of an optical fiber was placed in a vial, 20 mL of acetone was added thereto, and extraction was performed for 60 minutes using an ultrasonic cleaner. The extract was measured by gas chromatography (GC) to determine the contents (% by mass) of the phosphine oxide-based initiator and trimethylbenzoic acid in the optical fiber. “GC2030” manufactured by SHIMADZU CORPORATION was used as the measuring apparatus, and “UA-1” (non-polar, inner diameter 0.25 mm×length 30 m, film thickness 0.25 μm) manufactured by Frontier Laboratories Ltd. was used as the column. Regarding the measurement temperature, temperature was raised from 100° C. to 160° C. at a temperature increase rate of 20° C./min, subsequently temperature was raised to 230° C. at a temperature increase rate of 5° C./min, subsequently temperature was raised to 350° C. at a temperature increase rate of 60° C./min, and then the temperature was maintained at 350° C. for 15 minutes.

### (Coating Removal Force)

An optical fiber was immersed in a jelly (manufactured by SHANGHAI HONGHUI OPTICS COMMUNICATION TECH CO., LTD., trade name “LT-410”) at 85° C. for 120 days. The coating removal force (N) of the optical fiber was measured before and after the immersion according to JIS C 6821, and the average value of the coating removal force of the optical fiber was determined according to the international standards (IEC60793-1-2). The average value of the coating removal force according to the international standards was 1.0 N or greater and 5.0 N or less.

### (Pullout Force)

An optical fiber was disposed at a distance of 60 cm from a 40-W white fluorescent lamp, and the optical fiber was irradiated with light at 1000 lux at room temperature for 7 days. For the optical fiber before and after being irradiated with light at 1000 lux, the pullout force per 10 mm at the time of pulling out the coating resin layer from the glass fiber was measured on the basis of the method described in JP 2001-194565 A or the like. The change rate of the pullout force was calculated by the following formula.

$$Change rate ( \% ) = ( Pullout force after irradiation - pullout force before irradiation ) \text{} / pullout force before irradiation \times 100$$

TABLE 3

| Test Example | | 1 | 2 | 3 | 4 | 5 | 6 | 7 |
|---|---|---|---|---|---|---|---|---|
| Primary | Resin composition | P1 | P1 | P1 | P1 | P1 | P1 | P1 |
| resin layer | | | | | | | | |
| Secondary | Resin composition | S1 | S1 | S1 | S1 | S1 | S1 | S1 |
| resin layer | | | | | | | | |
| Optical | Phosphine oxide-based | 0.080 | 0.060 | 0.030 | 0.001 | 0.100 | 0.100 | 0.001 |
| fiber | photopolymerization | | | | | | | |
| | initiator | | | | | | | |
| | (% by mass) | | | | | | | |
| | Trimethylbenzoic acid | 0.005 | 0.010 | 0.020 | 0.001 | 0.200 | 0.001 | 0.200 |
| | (% by mass) | | | | | | | |
| Coating | Before immersion | 1.45 | 1.40 | 1.45 | 1.40 | 1.50 | 1.40 | 1.50 |
| removal | (N) | | | | | | | |
| force | After immersion | 1.30 | 1.25 | 1.00 | 1.01 | 1.47 | 1.10 | 1.40 |
| | (N) | | | | | | | |
| Pullout | Before irradiation | 7.16 | 7.45 | 7.85 | 8.92 | 8.53 | 8.92 | 8.24 |
| force | (N) | | | | | | | |
| | After irradiation | 7.85 | 8.34 | 8.34 | 9.02 | 13.63 | 12.26 | 12.94 |
| | (N) | | | | | | | |
| | Change rate (%) | 9.6 | 11.8 | 6.2 | 1.1 | 59.8 | 37.4 | 57.1 |

TABLE 4

| Test Example | | 8 | 9 | 10 | 11 | 12 | 13 | 14 |
|---|---|---|---|---|---|---|---|---|
| Primary | Resin composition | P1 | P1 | P2 | P3 | P4 | P5 | P6 |
| resin layer | | | | | | | | |
| Secondary | Resin composition | S7 | S8 | S2 | S3 | S4 | S5 | S6 |
| resin layer | | | | | | | | |
| Optical | Phosphine oxide- | 0.09 | 0.10 | 0.500 | 0.500 | 0.500 | 0.200 | 0.300 |
| fiber | based | | | | | | | |
| | photopolymerization | | | | | | | |
| | initiator | | | | | | | |
| | (% by mass) | | | | | | | |
| | Trimethylbenzoic | 0.008 | 0.007 | 0.002 | 0.100 | 0.002 | 0.100 | 0.110 |
| | acid | | | | | | | |
| | (% by mass) | | | | | | | |
| Coating | Before immersion | 1.60 | 1.40 | 1.40 | 1.50 | 1.40 | 1.40 | 1.35 |
| removal | (N) | | | | | | | |
| force | After immersion (N) | 1.37 | 1.31 | 1.10 | 1.45 | 1.15 | 1.35 | 1.28 |
| Pullout | Before irradiation | 7.30 | 7.21 | 6.77 | 7.75 | 7.35 | 7.35 | 7.06 |
| force | (N) | | | | | | | |
| | After irradiation (N) | 7.93 | 7.75 | 10.79 | 11.77 | 11.67 | 9.81 | 10.98 |
| | Change rate (%) | 8.6 | 7.5 | 59.4 | 51.9 | 58.7 | 33.3 | 55.6 |

TABLE 5

| | | Test Example | | | |
|---|---|---|---|---|---|
| | | 15 | 16 | 17 | 18 |
| Primary | Resin composition | P1 | P1 | P1 | P1 |
| resin layer | | | | | |
| Secondary | Resin composition | S1 | S1 | S1 | S1 |
| resin layer | | | | | |
| Optical | Phosphine | — | 0.0005 | 0.110 | 0.150 |
| fiber | oxide-based | | | | |
| | photopolymerization | | | | |
| | initiator | | | | |
| | (% by mass) | | | | |
| | Trimethylbenzoic | — | 0.240 | 0.0009 | 0.230 |
| | acid (% by mass) | | | | |
| Coating | Before immersion (N) | 1.30 | 1.50 | 1.40 | 1.60 |
| removal | After immersion (N) | 0.90 | 1.00 | 0.97 | 1.50 |
| force | | | | | |
| Pullout | Before irradiation (N) | 5.88 | 10.20 | 7.06 | 10.00 |
| force | After irradiation (N) | 5.98 | 17.65 | 12.06 | 21.97 |
| | Change rate (%) | 1.7 | 73.1 | 70.8 | 119.6 |

What is claimed is:

1. An optical fiber comprising:
a glass fiber including a core and a cladding; and
a coating resin layer covering the glass fiber,
wherein the coating resin layer includes a cured product of a resin composition containing a photopolymerizable compound and a phosphine oxide-based photopolymerization initiator, and trimethylbenzoic acid,
a content of the phosphine oxide-based photopolymerization initiator is 0.001% by mass or more and 0.5% by mass or less based on a total amount of the optical fiber, and
a content of the trimethylbenzoic acid is 0.0010% by mass or more and 0.2% by mass or less based on the total amount of the optical fiber.

2. The optical fiber according to claim 1, wherein the phosphine oxide-based photopolymerization initiator includes at least one selected from the group consisting of 2,4,6-trimethylbenzoyldiphenylphosphine oxide, 2,4,6-trimethylbenzoylphenylphosphonic acid ethyl ester, phenylbis(2,4,6-trimethylbenzoyl)phosphine oxide, and tri[phenyl(2,4,6-trimethylbenzoyl)phosphinic acid] polyethylene glycol ester.

3. The optical fiber according to claim 2, wherein the phosphine oxide-based photopolymerization initiator is 2,4,6-trimethylbenzoyldiphenylphosphine oxide, and
a content of the 2,4,6-trimethylbenzoyldiphenylphosphine oxide is 0.001% by mass or more and 0.1% by mass or less based on the total amount of the optical fiber.

4. The optical fiber according to claim 2, wherein the phosphine oxide-based photopolymerization initiator is 2,4,6-trimethylbenzoylphenylphosphonic acid ethyl ester, and
a content of the 2,4,6-trimethylbenzoylphenylphosphonic acid ethyl ester is 0.001% by mass or more and 0.5% by mass or less based on the total amount of the optical fiber.

5. The optical fiber according to claim 2, wherein the phosphine oxide-based photopolymerization initiator is phenylbis(2,4,6-trimethylbenzoyl)phosphine oxide, and
a content of the phenylbis(2,4,6-trimethylbenzoyl)phosphine oxide is 0.001% by mass or more and 0.5% by mass or less based on the total amount of the optical fiber.

6. The optical fiber according to claim 2, wherein the phosphine oxide-based photopolymerization initiator is tri[phenyl(2,4,6-trimethylbenzoyl)phosphinic acid] polyethylene glycol ester, and
a content of the tri[phenyl(2,4,6-trimethylbenzoyl)phosphinic acid] polyethylene glycol ester is 0.001% by mass or more and 0.5% by mass or less based on the total amount of the optical fiber.

7. An optical fiber ribbon comprising:
a plurality of the optical fibers according to claim 1 arranged in parallel; and
a connecting resin layer covering and connecting a plurality of the optical fibers.

8. An optical fiber cable comprising the optical fiber ribbon according to claim 7 housed in a cable.

9. An optical fiber cable comprising a plurality of the optical fibers according to claim 1 housed in a cable.
